(19) United States
(12) Patent Application Publication
(10) Pub. No.: US 2007/0123305 A1
(43) Pub. Date: May 31, 2007

(54) Method For Securing a Near Field Communication Device of a Mobile Phone

(76) Inventors: Chun-Wei Chen, Kao-Hsiung City (TW); Chih-Lin Hu, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/564,277

(22) Filed: Nov. 28, 2006

(30) Foreign Application Priority Data
Nov. 29, 2005 (TW) 094141978

(51) Int. Cl. H04M 1/00

(52) U.S. Cl. 455/558

(57) ABSTRACT

A security method includes reading an international mobile subscriber identity (IMSI) number of a subscriber identity module (SIM) card and an identity number of a near field communication (NFC) card of the mobile phone; detecting if the IMSI number matches first data stored in memory of the mobile phone, detecting if the identity number matches second data stored in the memory, and when the IMSI number and the identity number respectively match the first and the second set of data stored in the memory, the mobile phone enables the NFC card. The security method allows a consumer to feel more secure when the NFC card is used.

### BACKGROUND OF THE INVENTION

1. Field of the Invention

The present invention relates to a method for securing a mobile phone, and more particularly, to a method for securing a near field communication device of a mobile phone.

2. Description of the Prior Art

A near field communication (NFC) technology is a type of close range wireless technology utilized for exchanging data within a predetermined distance. A near field communication interface and protocol (NFCIP-1) have passed international standards ISO/IEC IS 18092. The frequency of the NFC technology is 13.56 MHz, which is lower than a frequency of 2.4 GHz such as Bluetooth or a wireless network, therefore, the frequency of the NFC is not easily interrupted. When devices having NFC cards come within a predetermined range, the devices can identify one another and exchange data.

Devices having an NFC card do not require any physical contact to sense other cards, therefore, the NFC technology is advantageous when applied to the areas of mobile commerce, e-commerce, and user identification. NFC cards are currently being installed into mobile phones. As mobile phones become more common, this provides more convenience for consumers. For example, a mobile phone that has an NFC card can utilize the NFC card as an electronic wallet to purchase goods, or utilize the NFC card as an identification card. Therefore, a consumer needs only bring a mobile phone when the consumer goes out eliminating the need for bringing a wallet or identification card.

However, the current NFC technology applied to the mobile phone does not include any corresponding security mechanism. When the mobile phone is lost, the consumer faces the consequences of the electronic wallet and identification card being misused.

### SUMMARY OF THE INVENTION

The claimed invention discloses a method for securing a near field communication device of a mobile phone. The method comprises reading an international mobile subscriber identity (IMSI) of a subscriber identity module (SIM) card and an identity number of a near field communication (NFC) card of the mobile phone; detecting if the IMSI number matches first data stored in memory of the mobile phone; detecting if the identity number matches second data stored in the memory of the mobile phone; and enabling a sensing function of the NFC card when the IMSI number and the identity number respectively match the first and the second data in the memory of the mobile phone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of a mobile phone having a near field communication (NFC) card according to the present invention.

FIG. 2 illustrates a flowchart of the present invention.

### DETAILED DESCRIPTION

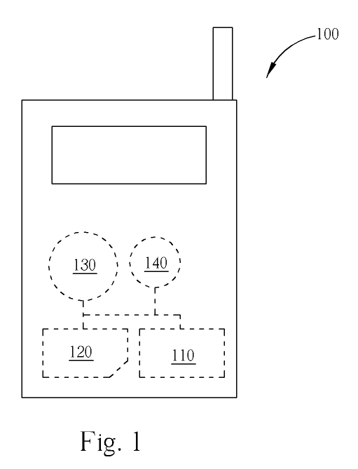

Please refer to FIG. 1. FIG. 1 illustrates a diagram of a mobile phone 100 having a near field communication (NFC) card according to the present invention. The mobile phone 100 of the present invention includes a slot for placing a subscriber identity module (SIM) card 120 and reading data of the SIM card 120 and the NFC card 110. The SIM card 120 stores data such as telephone numbers, phone books, and personal identification numbers (PIN). When a global system for mobile communication (GSM) is utilized, a valid SIM card 120 is required to connect to a communication network of the GSM system to perform data exchange. Each SIM card 120 has an international mobile subscriber identity (IMSI) number for identifying an individual user, thus each IMSI number is unique. Furthermore, each NFC card 110 includes a unique identity number. Therefore, the present invention utilizes the unique characteristic of the IMSI number and the identity number to provide a method for securing a near field communication device of the mobile phone 100.

For example, when the mobile phone 100 having the NFC card 110 is switched on for the first time, a system 130 of the mobile phone 100 will read the IMSI number of the SIM card and the identity number of the NFC card 110 and store the IMSI number and the identity number into memory 140. Subsequently, each time the mobile phone 100 is switched on, the system 130 of the mobile phone 100 will automatically read and compare an IMSI number of the SIM card and a identity number of the NFC card 110 with the IMSI number and the identity number previously stored in the memory 140. If the IMSI number of the SIM card 120 matches the IMSI number stored in the memory unit 140, and the identity number of the NFC card 110 matches the identity number stored in the memory unit 140, then the system 130 of the mobile phone 100 will enable a sensing function of the NFC card 110. On the contrary, when the IMSI number of the SIM card 120 does not match the IMSI number stored in the memory unit 140, or the identity number of the NFC card 110 does not match the identity number stored in the memory unit 140, for instance, the SIM card 120 or the NFC card 110 is changed, the system 130 of the mobile phone 100 will not enable the sensing function of the NFC card 110. In this case, a user is required to input a password to verify the user's identity. If the password is accurate, the system 130 of the mobile phone 100 will then enable the sensing function of the NFC card 110.

Furthermore, if during the operation period after the mobile phone 100 is switched on it is detected that the SIM card 120 is being withdrawn from the mobile phone 100 (i.e., the SIM card 120 is not detected), the system 130 of the mobile phone 100 will immediately terminate the sensing function of the NFC card. The above-mentioned comparison sequence is then executed again to prevent the mobile phone 100 from misused. In an embodiment of the present invention, the memory 140 directly stores the IMSI number of the SIM card 120 and the identity number of the NFC card 110, however the present invention can also generate first data and second data according to the IMSI number of the SIM card 120 and the identity number of the NFC card 110, and the first and second data can be stored into the memory 140 to be utilized for comparison with the IMSI number of the SIM card 120 and the identity number of the NFC card 110.

However, the NFC card 110 can also be misused if the user loses the mobile phone 100. Therefore, when the mobile phone of the present invention having the NFC card 110 is switched on for the first time, the system 130 of the mobile phone 100 requests that the user input and store a first predetermined message and a second predetermined message into the memory 140. The user can self-select the predetermined messages. Later, when the mobile phone 100 receives a content that matches the first predetermined message, the system 130 of the mobile phone 100 will disable the sensing function of the NFC card 110. When the mobile phone 100 receives a content that matches the second predetermined message, the system 130 of the mobile phone 100 will enable the sensing function of the NFC card 110. Therefore, when the user discovers that the mobile phone 100 is lost, in order to prevent the NFC card 110 from misuse, the user can remotely transmit a message that matches the first predetermined message to the mobile phone 100 to disable the sensing function of the NFC card 110. If the user finds the mobile phone 100, the user can transmit a message that matches the second predetermined message to the mobile phone 100 to enable the sensing function of the NFC card 110. Furthermore, if the mobile phone 100 is stolen and currently switched off, the mobile phone 100 is unable to receive text messages, however, according to the short message service (SMS) protocol, the text message will be temporarily stored in a message center. Once the mobile phone 100 is switched on later, the text message will be transmitted to the mobile phone 100 from the message center. Therefore, the remote control security mechanism of the mobile phone 100 cannot be evaded by switching off the mobile phone 100. Regardless of a text message for enabling NFC function or a text message for disabling NFC function (e.g., to enable or disable the sensing function of the NFC card 110), the mobile phone 100 stores an operation status of the NFC card 110, therefore if the mobile phone 100 is switched off, the mobile phone 100 will maintain the previous operation status of the NFC card 110. For example, if the sensing function of the NFC card 110 has been disabled, the mobile phone 100 will maintain the disable status even if the mobile phone 100 is switched on again, or vice versa.

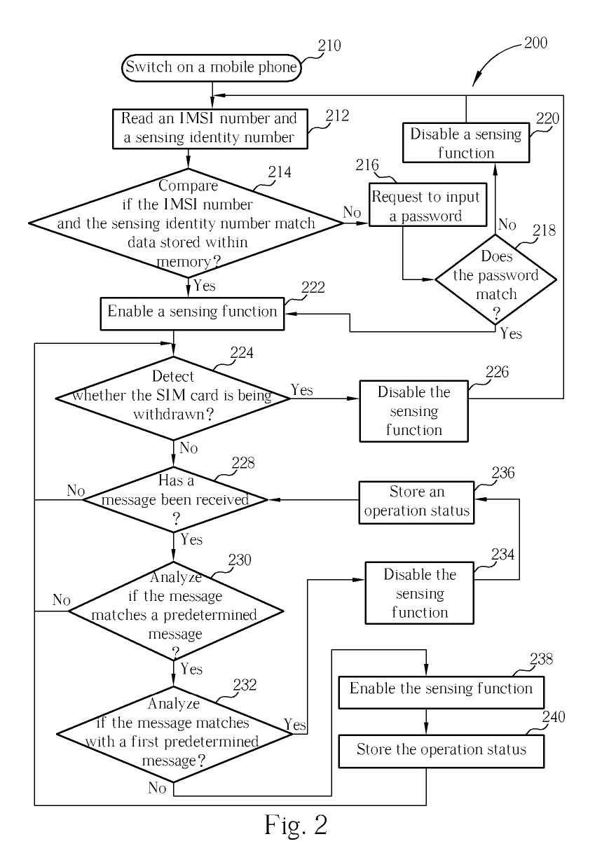

To further explain the method of the present invention, FIG. 2 provides a flowchart 200 of the present invention. Please refer to FIG. 2, and at the same time refer to FIG. 1. The flowchart 200 of FIG. 2 includes the following steps:

Step 210: switch on the mobile phone 100;

Step 212: read the IMSI number of the SIM card 120 and the identity number of the NFC card 110;

Step 214: compare the IMSI number of the SIM card 120 and the identity number of the NFC card 110 to data stored within memory 140, if they match, proceed to step 222, if not proceed to step 216;

Step 216: the mobile phone 100 requests a user to input a password;

Step 218: analyze if the password matches, if so proceed to step 222, if not proceed to step 220;

Step 220: disable a sensing function of the NFC card 110 and proceed to step 212;

Step 222: enable the sensing function of the NFC card 110;

Step 224: detect whether the SIM card is being withdrawn, if so proceed to step 226, if not proceed to step 228;

Step 226: disable the sensing function of the NFC card and proceed to step 212;

Step 228: determine if the mobile phone 100 has received a message, if so proceed to step 230, if not proceed to step 224;

Step 230: analyze if the message matches a predetermined message, if so proceed to step 232, if not proceed to step 224;

Step 232: analyze if the message matches with a first predetermined message, if so proceed to step 234, if not proceed to step 238;

Step 234: disable the sensing function of the NFC card 110 and proceed to step 236;

Step 236: store an operation status of the NFC card 110 and proceed to step 228;

Step 238: enable the sensing function of the NFC card 110 and proceed step 240; and

Step 240: store the operation status of the NFC card 110 and proceed to step 224.

It is not necessary to sequentially follow the steps of the flowchart 200 to achieve the same result. In other words, each of the steps is not required to be exactly adjacent as shown. Other steps can be successfully inserted between the above steps while maintaining the operation according to the present invention. Furthermore, the method of the present invention of utilizing the message to enable or disable the sensing function of the NFC card 110 can be applied to other mobile phones of other non-GSM systems. Mobile phones operating without a SIM card can also utilize the above method of remote control by text message. The present invention can be realized through software, software with firmware, hardware, or any combination of the above-mentioned components.

In comparison to the prior art, the present invention provides a method for securing a near field technology application utilized in the mobile phone 100 such that a consumer can feel more secure when utilizing the NFC card 110.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for securing a near field communication device of a mobile phone, the method comprising:
(a) reading an international mobile subscriber identity (IMSI) of a subscriber identity module (SIM) card and an identity number of a near field communication (NFC) card of the mobile phone;
(b) detecting if the IMSI number matches first data stored in memory of the mobile phone;
(c) detecting if the identity number matches second data stored in the memory of the mobile phone; and
(d) enabling a sensing function of the NFC card when the IMSI number and the identity number respectively match the first and the second data in the memory of the mobile phone.

2. The method of claim 1 wherein step (a) is reading the international mobile subscriber identity (IMSI) of the subscriber identity module (SIM) card and the identity number of the near field communication (NFC) card of the mobile phone when the mobile phone is enabled.

3. The method of claim 1 further comprising disabling the sensing function of the NFC card when the SIM card is not detected.

4. The method of claim 1 further comprising inputting a predetermined message into the mobile phone.

5. The method of claim 4 further comprising disabling the sensing function of the NFC card when the mobile phone receives a message matching the predetermined message.

6. The method of claim 4 further comprising enabling the sensing function of the NFC card when the mobile phone receives a message matching the predetermined message.

7. A method for securing a near field communication device of a mobile phone, the method comprising:
(a) reading an international mobile subscriber identity (IMSI) of a subscriber identity module (SIM) card and an identity number of a near field communication (NFC) card of the mobile phone;
(b) requesting a password when the IMSI number does not match first data stored in memory of the mobile phone or when the identity number of the NFC card does not match second data stored in the memory of the mobile phone; and
(c) enabling a sensing function of the NFC card when an inputted password matches a predetermined password.

8. The method of claim 7 wherein step (a) is reading the international mobile subscriber identity (IMSI) of the subscriber identity module (SIM) card and the identity number of the near field communication (NFC) card of the mobile phone when the mobile phone is enabled.

9. The method of claim 7 further comprising disabling the sensing function of the NFC card when the SIM card is not detected.

10. The method of claim 7 further comprising inputting a predetermined message into the mobile phone.

11. The method of claim 10 further comprising disabling the sensing function of the NFC card when the mobile phone receives a message matching the predetermined message.

12. The method of claim 10 further comprising enabling the sensing function of the NFC card when the mobile phone receives a message matching the predetermined message.

13. A method of remotely controlling a near field communication device of a mobile phone, the method comprising:
(a) inputting a first predetermined message into a mobile phone; and
(b) disabling a sensing function of a near field communication (NFC) card when the mobile phone receives a message matching the first predetermined message.

14. The method of claim 13 further comprising inputting a second predetermined message into the mobile phone.

15. The method of claim 14 further comprising enabling the sensing function of the NFC card when the mobile phone receives a message matching the second predetermined message.

16. The method of claim 13 further comprising storing an operation status of the NFC card.
